(19) United States
(12) Patent Application Publication
(10) Pub. No.: US 2026/0063451 A1
(43) Pub. Date: Mar. 5, 2026

(54) SENSOR WITH ELECTRICALLY CONDUCTIVE SENSING ELEMENT

(71) Applicant: Northrop Grumman Systems Corporation, Falls Church, VA (US)

(72) Inventors: Grant Camden Miars, San Diego, CA (US); Scott R. Burnside, Rescue, CA (US); Thomas J. Roush, Carmichael, CA (US)

(21) Appl. No.: 18/823,840

(22) Filed: Sep. 4, 2024

(51) Int. Cl. G01D 11/24; G01K 1/08; G01K 7/00; G01L 1/00

(52) U.S. Cl. CPC G01D 11/245; G01K 1/08; G01K 7/00; G01L 1/00

(57) ABSTRACT

A sensor includes a first electrical terminal, a second electrical terminal, and a self-passivating sensing element coupled between the first electrical terminal and the second electrical terminal such that an electric current may flow through the self-passivating sensing element from the first electrical terminal to the second electrical terminal. An electrical property of the self-passivating sensing element varies based on at least one of a temperature of an environment in which the sensor is positioned or a specimen to which the sensor is coupled, a pressure being applied to the self-passivating sensing element by the environment, or a strain being experienced by the specimen.

### FIELD

The present disclosure generally relates to sensors and, more particularly, to sensors with electrically conductive sensing elements.

### BACKGROUND

Various types of sensors, including certain temperature, pressure, and strain sensors, rely on an electrically conductive sensing element to measure a parameter or other property of a specimen or an environment in which the sensor is placed. For example, variations in the temperature of the environment, the pressure being applied to the sensing element, or the strain of the specimen can cause changes in the electrical properties of the sensing elements. Based on these changes, the temperature, pressure, or strain can be determined.

An electrically conductive sensing element must be protected before the sensor is used in a harsh environment, such as, but not limited to, an outdoor, undersea, humid, and/or caustic environment. Without protection, the water or other electrically conductive media present in the environment can cause the electrically conductive sensing element to short out. Thus, before use in a harsh environment, the electrically conductive sensing elements are encapsulated within an electrically insulative epoxy or housing. However, such encapsulation reduces the accuracy and/or speed of the measurements captured by the sensor. For example, in the context of a temperature sensor, the epoxy or housing acts as a thermal resistance between the environment and the sensing element, reducing and/or slowing the transfer of heat from the environment to the sensing element. Similarly, in the context of a pressure or strain sensor, the epoxy or housing can reduce the ability of the sensing element to flex or bend, which changes its electrical properties, in response to the application of pressure or strain to the sensor or a specimen on which the sensor is mounted.

Accordingly, an improved sensor with an electrically conductive sensing element would be welcomed in this technology domain.

### SUMMARY

Aspects and advantages of the technology will be set forth in part in the following description, or may be obvious from the description, or may be learned through practice of the technology.

In one aspect, the present disclosure is directed to a sensor including a first electrical terminal, a second electrical terminal, and a self-passivating sensing element coupled between the first electrical terminal and the second electrical terminal such that an electric current may flow through the self-passivating sensing element from the first electrical terminal to the second electrical terminal. In this respect, an electrical property of the self-passivating sensing element varies based on at least one of a temperature of an environment in which the sensor is positioned or a specimen to which the sensor is coupled, a pressure being applied to the self-passivating sensing element by the environment, or a strain being experienced by the specimen.

In another aspect, the present disclosure is directed to a temperature sensor including a first electrical terminal, a second electrical terminal, and a self-passivating sensing element coupled between the first electrical terminal and the second electrical terminal such that an electric current may flow through the self-passivating sensing element from the first electrical terminal to the second electrical terminal. As such, an electrical property of the self-passivating sensing element varies based on at least one of a temperature of an environment in which the temperature sensor is positioned or a specimen to which the temperature sensor is coupled.

In a further aspect, the present disclosure is directed to a strain sensor including a first electrical terminal, a second electrical terminal, and a self-passivating sensing element coupled between the first electrical terminal and the second electrical terminal such that an electric current may flow through the self-passivating sensing element from the first electrical terminal to the second electrical terminal. In this regard, an electrical property of the self-passivating sensing element varies based on a strain experienced by a specimen to which the strain sensor is coupled.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology directed to one of ordinary skill in the art, is set forth in the specification, which makes reference to the appended figures, in which:

FIG. 1 illustrates a diagrammatic, cross-sectional view of one embodiment of a sensor in accordance with aspects of the present disclosure;

FIG. 2 illustrates a diagrammatic, cross-sectional view of another embodiment of a sensor in accordance with aspects of the present disclosure;

FIG. 3 illustrates a partial, cross-sectional view of a further embodiment of a sensor in accordance with aspects of the present disclosure; and

FIG. 4 illustrates a cross-sectional view of a yet another embodiment of a sensor in accordance with aspects of the present disclosure.

Repeat use of reference characters in the present specification and drawings is intended to represent the same or analogous features or elements of the present technology.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

The terms “environment” and “specimen” will be used below when describing the structure and operation of the sensor disclosed herein. Specifically, the term environment refers to the fluid medium in which the sensor is immersed or otherwise positioned. For example, the environment can be air (such as with varying levels of moisture), water, oil, and/or the like. Conversely, the term specimen refers to a solid component or structure to which the sensor is coupled or otherwise mechanically attached. For example, the specimen can be a housing, a gear, a beam, a rod, a shaft, a cover, a hatch, and/or the like.

In general, the present disclosure is directed to a sensor, such as a temperature sensor, a pressure sensor, or a strain sensor. Specifically, in several embodiments, the sensor includes a first electrical terminal and a second electrical terminal. Furthermore, the sensor includes a self-passivating sensing element coupled between the first electrical terminal and the second electrical terminal such that an electric current may flow through the self-passivating sensing element from the first electrical terminal to the second electrical terminal. In this respect, one or more electrical properties of the self-passivating sensing element, such as its resistance or capacitance, vary based on the temperature of an environment in which the sensor is positioned or a specimen to which the sensor is coupled, the pressure being applied to the self-passivating sensing element by the environment or the specimen, and/or a strain experienced by the specimen.

The self-passivating sensing element improves the operation of the sensor. More specifically, the self-passivating sensing element forms an electrically insulative passivation layer (e.g., an oxide or hydroxide layer) on the exterior surface of the sensing element, such as when the sensing element is exposed to water. Example self-passivating materials include niobium, tantalum, titanium, zirconium, molybdenum, ruthenium, rhodium, palladium, hafnium, tungsten, rhenium, osmium, and iridium. The passivation layer electrically insulates the sensing element from water or other electrically conductive media present within the environment in which the sensor is present, thereby preventing the sensor from shorting out. In this respect, the self-passivating sensing element can be placed in direct contact (e.g., without the need for a protective housing or epoxy encapsulation) with a harsh environment, such as, but not limited to, an outdoor, undersea, humid, and/or caustic environment. Moreover, the passivation layer provides significantly less physical isolation (e.g., less thermal resistance, less resistance to bending or flexing, etc.) of the electrically conductive portion of the self-passivating sensing element from the environment and/or specimen than a conventional housing or epoxy encapsulation. Thus, the self-passivating sensing element allows the sensor to provide quicker and more accurate measurements in a smaller total volume.

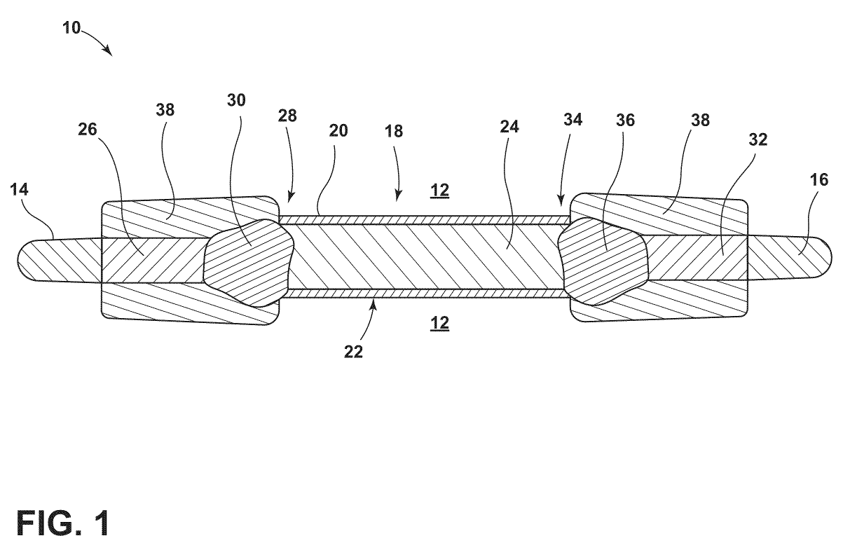

Referring now to the drawings, FIG. 1 illustrates a diagrammatic, cross-sectional view of one embodiment of a sensor 10 in accordance with aspects of the present disclosure. In general, the sensor 10 is configured to detect or measure one or more properties of a specimen (not shown) or an environment 12 in which the sensor 10 is placed. For example, in some embodiments, the sensor 10 may be configured as a temperature sensor. In other embodiments, the sensor 10 may be configured as a pressure sensor. In further embodiments, the sensor 10 may be configured as a strain sensor. However, in alternative embodiments, the sensor 10 may be configured as any other suitable type of sensor or sensing device.

As shown, the sensor 10 includes a first electrical terminal 14 and a second electrical terminal 16. More specifically, the first and second electrical terminals 14, 16 are electrically conductive components that electrically couple the sensor 10 to external circuitry (not shown) or an electronic component(s) (not shown), such as a controller or computing system. In this respect, the first electrical terminal 14 is configured to receive electric current from the external circuitry or electronic component(s) for use by the sensor 10. Conversely, the second electrical terminal 16 is configured to provide the electric current having passed through the sensor 10 back to the external circuitry or electronic component(s). For example, the first and second electrical terminals 14, 16 may be pins, contacts, sockets, or any other suitable electrically conductive devices that can facilitate an electrical coupling between the sensor 10 and the external circuitry or electronic component(s). Additionally, in some embodiments, the sensor 10 may include additional terminals, such as a ground terminal.

The first and second electrical terminals 14, 16 may be positioned at any suitable location on the sensor 10. For example, in the illustrated embodiment, the first and second electrical terminals 14, 16 are positioned on opposing sides of the sensor 10. However, in alternative embodiments, the first and second electrical terminals 14, 16 may be positioned on the same side of the sensor 10. In one embodiment, the first and second electrical terminals 14, 16 may be integrated into a single electrical connector (not shown).

Furthermore, the sensor 10 includes a self-passivating sensing element 18. More specifically, the self-passivating sensing element 18 is coupled (e.g., electrically coupled) between the first electrical terminal 14 and the second electrical terminal 16. As such, during operation of the sensor 10, an electric current flows through the self-passivating sensing element 18 from the first electrical terminal 14 to the second electrical terminal 16. In this respect, one or more electrical properties, such as the resistance and/or capacitance, of the self-passivating sensing element 18 can change in response to a change in environment 12 or the specimen. For example, the electrical properties of the self-passivating sensing element 18 can vary based on the temperature of the environment 12, the pressure being applied to the self-passivating sensing element 18 by the environment 12, or the strain experienced by the specimen. This change in the electrical properties of the self-passivating sensing element 18, in turn, varies the characteristics of the electric current (e.g., its voltage, amperage, etc.) flowing through the self-passivating sensing element 18. Thus, based on the difference in the electric current characteristics(s) across the first and second electrical terminals 14, 16, the temperature of the environment 12 or the specimen, the pressure within the environment 12 or acting on the specimen, and/or strain experienced by the specimen can be determined.

The self-passivating sensing element 18 is at least partially formed from a self-passivating material. That is, the self-passivating sensing element 18 includes an electrically conductive material forming an electrically insulative passivation layer when exposed to the environment. More specifically, a self-passivating material is a material that forms an electrically insulative passivation layer on its exterior surface when exposed to the environment (e.g., the water present in the environment). In this respect, the passivation layer may be oxides, hydroxides, or other electrically insulative compounds. For example, as shown in FIG. 1, a passivation layer 20, which is electrically insulative, is formed on an exterior surface 22 of the self-passivating sensing element 18. Thus, the passivation layer 20 electrically insulates an underlying electrically conductive portion 24 of the self-passivating sensing element 18 from the environment 12.

The use of the self-passivating material in the construction of the self-passivating sensing element 18 provides one or more technical advantages. Moreover, the passivation layer 20 prevents the self-passivating sensing element 18 from shorting out when exposed to electrically conductive media (e.g., water) present within the environment 12. In this respect, the self-passivating sensing element 18 can be placed in direct contact (e.g., without the need for a protective housing or epoxy encapsulation) with the environment 12. That is, the electrically conductive media (e.g., water) can touch the exterior surface 22 of the self-passivating sensing element 18. Moreover, the passivation layer 20 provides significantly less physical isolation (e.g., less thermal resistance, less resistance to bending or flexing, etc.) of the electrically conductive portion 24 of the self-passivating sensing element 18 from the environment 12 and/or specimen than the housing or epoxy encapsulation. Thus, the self-passivating sensing element 18 allows the sensor 10 to provide quicker and more accurate measurements than conventional sensors in a smaller total volume.

The self-passivating material may be an electrically conductive material selected from a group containing niobium, tantalum, titanium, zirconium, molybdenum, ruthenium, rhodium, palladium, hafnium, tungsten, rhenium, osmium, and iridium. For example, in some embodiments, the self-passivating sensing element 18 may be formed from niobium. In such embodiments, the passivation layer 20 may be an oxide of niobium, such as Nb₂O₅.

Additionally, in the illustrated embodiment, the self-passivating sensing element 18 is entirely formed of the self-passivating material. While self-passivating materials are typically more expensive than non-self-passivating materials, forming the self-passivating sensing element 18 entirely from a self-passivating material, such as niobium, may simplify the manufacturing process of the self-passivating sensing element 18. However, as will be described below, the self-passivating sensing element 18 may only be partially formed from a self-passivating material.

Furthermore, the self-passivating sensing element 18 may be formed in any suitable shape or have any suitable structure. For example, in the illustrated embodiment, the self-passivating sensing element 18 is configured as a wire. In this respect, the sensor 10 may be mechanically coupled to a specimen and placed in the environment 12. As such, the self-passivating sensing element 18, namely the wire, can stretch and compress in response to changes to the environment 12 or the specimen, thereby changing its diameter and, thus, its resistance. However, as will be described below, the self-passivating sensing element 18 may be formed in a variety of other suitable shapes and/or structures.

Moreover, in several embodiments, the sensor 10 may include a non-self-passivating first electrical conduit 26. More specifically, the non-self-passivating first electrical conduit 26 extends from the first electrical terminal 14 to a first end 28 of the self-passivating sensing element 18. In this respect, the non-self-passivating first electrical conduit 26 may be mechanically coupled to the first electrical terminal 14 in any suitable manner, such as via soldering, crimping, riveting, etc. In one embodiment, the non-self-passivating first electrical conduit 26 and the first electrical terminal 14 form different portions of the same component. Furthermore, the non-self-passivating first electrical conduit 26 may be mechanically coupled to the self-passivating sensing element 18 via a solder connection 30. Thus, the non-self-passivating first electrical conduit 26 transmits electric current from the first electrical terminal 14 to the self-passivating sensing element 18.

Additionally, in several embodiments, the sensor 10 may include a non-self-passivating second electrical conduit 32. More specifically, the non-self-passivating second electrical conduit 32 extends from a second end 34 of the self-passivating sensing element 18 to the second electrical terminal 16. In this respect, the non-self-passivating second electrical conduit 32 may be mechanically coupled to the self-passivating sensing element 18 via a solder connection 36. Moreover, the non-self-passivating second electrical conduit 32 may be mechanically coupled to the second electrical terminal 16 in any suitable manner, such as via soldering, crimping, riveting, etc. In one embodiment, the non-self-passivating second electrical conduit 32 and the second electrical terminal 16 may form different portions of the same component. Thus, the non-self-passivating second electrical conduit 32 transmits electric current from the self-passivating sensing element 18 to the second electrical terminal 16.

The use of non-self-passivating materials in the first and second electrical conduits 26, 32 may reduce the cost of constructing the sensor 10. As mentioned above, self-passivating materials are generally more expensive than non-self-passivating materials. Thus, by fabricating portions of the sensor 10 for which direct contact with the environment 12 does not provide an improvement to its operation, namely the non-self-passivating first and second electrical conduits 26, 32, the cost of the sensor 10 can be reduced.

The non-self-passivating first and second electrical conduits 26, 32 may be configured as any suitable component for conveying electric current. For example, the non-self-passivating first and second electrical conduits 26, 32 may be configured as wires, printed circuitry, and/or the like. However, in alternative embodiments, the first and second electrical conduits 26, 32 may be formed from self-passivating materials.

Moreover, in some embodiments, the sensor 10 may include an encapsulation material 38. In general, the encapsulation material 38 isolates the non-self-passivating first and second electrical conduits 26, 32 from the environment 12. This, in turn, prevents any electrically conductive media present within the environment 12 from shorting out the non-self-passivating first and second electrical conduits 26, 32. However, the encapsulation material 38 does not encapsulate or otherwise isolate the self-passivating sensing element 18 from the environment 12.

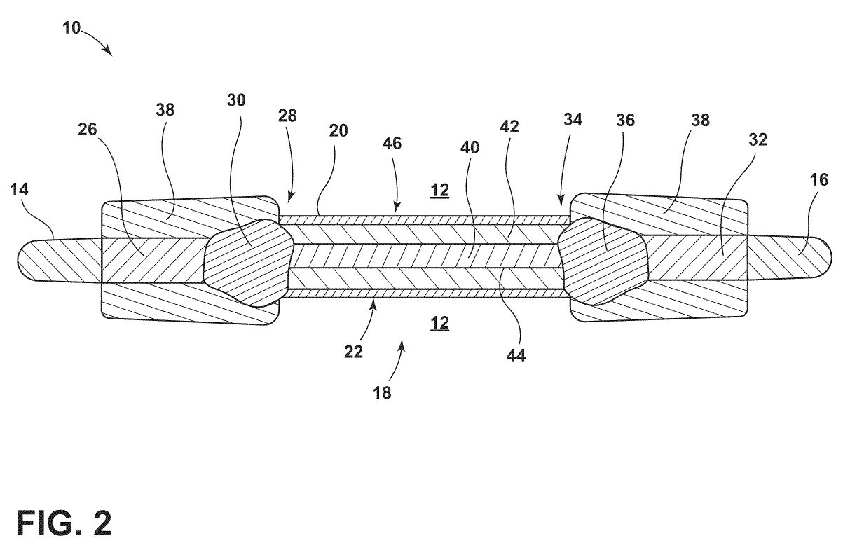

FIG. 2 illustrates a diagrammatic, cross-sectional view of another embodiment of the sensor 10 in accordance with aspects of the present disclosure. Like the embodiment of FIG. 1, the sensor 10 shown in FIG. 2 includes the first and second electrical terminals 14, 16; the self-passivating sensing element 18; the non-self-passivating first and second electrical conduits 26, 32, and the encapsulation material 38. However, unlike the embodiment of FIG. 1, the self-passivating sensing element 18 of the sensor 10 shown in FIG. 2 is not entirely formed of a self-passivating material. Rather, as shown in FIG. 2, the self-passivating sensing element 18 includes a non-self-passivating core or base layer 40 and a self-passivating coating 42 applied to an exterior surface 44 of the non-self-passivating base layer 40. In this respect, the passivation layer 20, which is electrically insulative, is formed on an exterior surface 46 of the self-passivating coating 42 (which corresponds to the exterior surface 22 of the self-passivating sensing element 18). Such a configuration reduces the amount of self-passivating material needed to fabricate the self-passivating sensing element 18, which may reduce the cost of such fabrication.

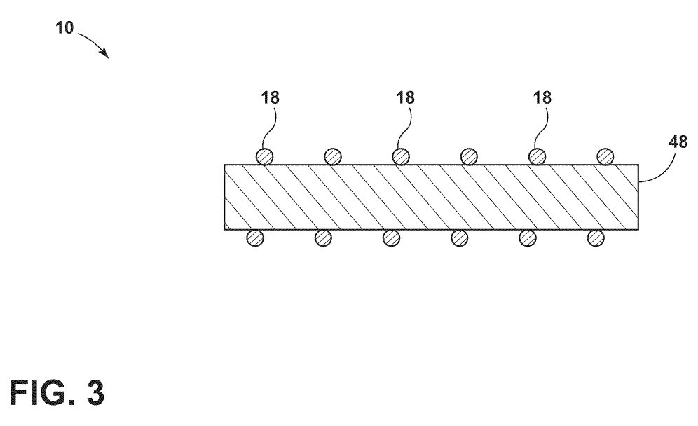

FIG. 3 illustrates a partial, cross-sectional view of a further embodiment of the sensor 10 in accordance with aspects of the present disclosure. Like the embodiments of FIGS. 1 and 2, the sensor 10 shown in FIG. 3 includes the self-passivating sensing element 18 configured as a wire. However, unlike the embodiments of FIGS. 1 and 2, the self-passivating sensing element 18 of the sensor 10 shown in FIG. 3 is configured as a coiled wire wrapped circumferentially about a bobbin 48.

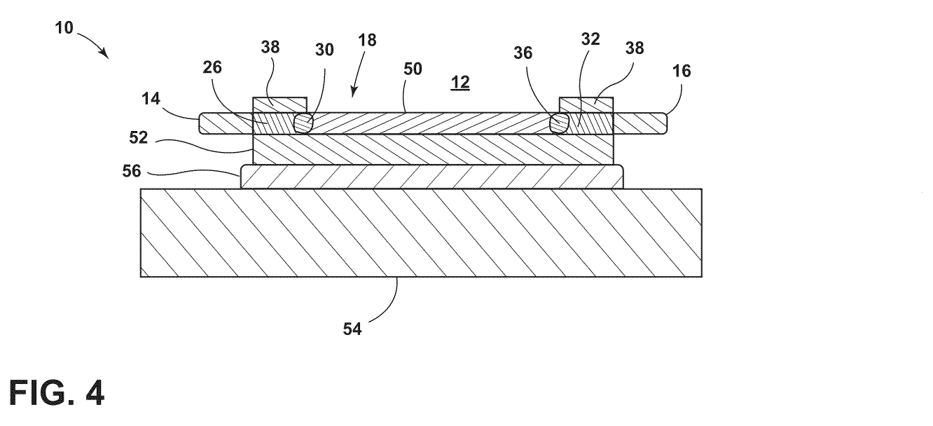

FIG. 4 illustrates a cross-sectional view of yet another embodiment of the sensor 10 in accordance with aspects of the present disclosure. Like the embodiment of FIGS. 1-3, the sensor 10 shown in FIG. 4 includes the first and second electrical terminals 14, 16; the self-passivating sensing element 18; the non-self-passivating first and second electrical conduits 26, 32, and the encapsulation material 38.

However, unlike the embodiment of FIGS. 1-3, the self-passivating sensing element 18 of the sensor 10 shown in FIG. 4 is not configured as a wire. Rather, as shown in FIG. 4, the self-passivating sensing element 18 is as a film 50. More specifically, as shown in FIG. 4, the film 50 is formed of a self-passivating material, such as niobium, deposited (e.g., via printing, sputtering, etc.) onto a substrate 52. In some embodiments, the film 50 may be a thin film (e.g., a film having a thickness of less than 1 micron, such 0.1 microns). In other embodiments, the film 50 may be a thick film (e.g., a film having a thickness of 1 micron or greater, such as 100 microns). Moreover, the substrate 52 may be mechanically coupled to a specimen 54 positioned within the environment 12 via a thermal paste or adhesive 56. In addition, the substrate 52 may be electrically insulative.

As described above, FIGS. 1-4 show differing exemplary shapes and configurations of the self-passivating sensing element 18, such as wires and films deposited on a substrate. However, self-passivating sensing element 18 may be configured as any other suitable electrically conductive component formed of a self-passivating material that can be used to measure or detect a property (e.g., temperature, pressure, strain, etc.) associated with a specimen or an environment based on changes in the electrical properties of such component caused by the specimen or the environment.

This written description uses examples to disclose the technology to enable any person skilled in the art to practice the technology, including making and using any devices or systems and performing any incorporated methods. The patentable scope of the technology is defined by the claims and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A sensor, comprising:
a first electrical terminal;
a second electrical terminal; and
a self-passivating sensing element coupled between the first electrical terminal and the second electrical terminal configured to allow an electric current to flow through the self-passivating sensing element from the first electrical terminal to the second electrical terminal,
wherein an electrical property of the self-passivating sensing element varies based on at least one of:
a temperature of:
an environment in which the sensor is positioned, or
a specimen to which the sensor is coupled,
a pressure being applied to the self-passivating sensing element by the environment, or
a strain being experienced by the specimen.

2. The sensor of claim 1, wherein the self-passivating sensing element is configured to be in direct contact with the environment.

3. The sensor of claim 1, wherein the self-passivating sensing element comprises an electrically conductive material forming an electrically insulative passivation layer when exposed to the environment.

4. The sensor of claim 3, wherein the electrically conductive material is selected from a group containing niobium, tantalum, titanium, zirconium, molybdenum, ruthenium, rhodium, palladium, hafnium, tungsten, rhenium, osmium, and iridium.

5. The sensor of claim 4, wherein the electrically conductive material is niobium.

6. The sensor of claim 1, wherein the self-passivating sensing element comprises a non-self-passivating base layer and a self-passivating coating applied to an exterior surface of the non-self-passivating base layer.

7. The sensor of claim 1, wherein the self-passivating sensing element is entirely formed of a self-passivating material.

8. The sensor of claim 1, further comprising:
a non-self-passivating first electrical conduit extending from the first electrical terminal to a first end of the self-passivating sensing element; and
a non-self-passivating second electrical conduit extending from a second end of the self-passivating sensing element to the second electrical terminal.

9. The sensor of claim 8, further comprising:
an encapsulation material isolating the non-self-passivating first electrical conduit and the non-self-passivating second electrical conduit from the environment.

10. The sensor of claim 1, wherein the self-passivating sensing element is a wire.

11. The sensor of claim 1, wherein the self-passivating sensing element is a coiled wire.

12. The sensor of claim 1, further comprising:
a substrate configured to be coupled to the specimen,
wherein the self-passivating sensing element is a thin film applied to the substrate.

13. The sensor of claim 1, further comprising:
a substrate configured to be coupled to the specimen,
wherein the self-passivating sensing element is a thick film applied to the substrate.

14. The sensor of claim 1, wherein the electrical property of the self-passivating sensing element varies based on the temperature of the environment.

15. The sensor of claim 1, wherein the electrical property of the self-passivating sensing element varies based on the pressure being applied to the self-passivating sensing element by the environment.

16. The sensor of claim 1, wherein the electrical property of the self-passivating sensing element varies based on the strain being applied the self-passivating sensing element by the specimen.

17. A temperature sensor, comprising:
a first electrical terminal;
a second electrical terminal; and
a self-passivating sensing element coupled between the first electrical terminal and the second electrical terminal and configured to allow an electric current to flow through the self-passivating sensing element from the first electrical terminal to the second electrical terminal,
wherein an electrical property of the self-passivating sensing element varies based on at least one of:
a temperature of:
an environment in which the temperature sensor is positioned,
or
a specimen to which the temperature sensor is coupled.

18. The temperature sensor of claim 17, wherein the self-passivating sensing element is configured to be in direct contact with the environment.

19. A strain sensor, comprising:
a first electrical terminal;
a second electrical terminal; and
a self-passivating sensing element coupled between the first electrical terminal and the second electrical terminal and configured to allow an electric current to flow through the self-passivating sensing element from the first electrical terminal to the second electrical terminal,
wherein an electrical property of the self-passivating sensing element varies based on a strain experienced by a specimen to which the strain sensor is coupled.

20. The strain sensor of claim 19, wherein the self-passivating sensing element is configured to be in direct contact with the environment.
